(19) United States
(12) Patent Application Publication
(10) Pub. No.: US 2016/0185012 A1
(43) Pub. Date: Jun. 30, 2016

(54) HOT VISCOUS RAW MATERIAL LEAVING A COOLER PERFORATED BODY COOLING A CUTTER

(71) Applicants: TECHNISCHE UNIVERSITÄT GRAZ, Graz (AT); RESEARCH CENTER PHARMACEUTICAL ENGINEERING GMBH, Graz (AT)

(72) Inventors: Daniel Treffer, St. Gertraud (AT); Johannes Khinast, Graz (AT); Johann Grubbauer, Graz (AT); Andreas Eitzlmayr, Graz (AT); Gerold Koscher, Graz (AT); Thomas Klein, Kindberg (AT)

(21) Appl. No.: 14/912,073

(22) PCT Filed: Aug. 14, 2014
(86) PCT No.: PCT/EP2014/067449

§ 371 Date: Feb. 12, 2016

(30) Foreign Application Priority Data
Aug. 14, 2013 (GB) 1314583.4

(51) Int. Cl. B29B 9/06; B29C 47/86; B29C 47/30; B29C 47/82; B29C 47/00; B29C 47/40

(52) U.S. Cl. CPC B29B 9/06; B29C 47/0066; B29C 47/0011; B29C 47/402; B29C 47/30; B29C 47/822; B29C 47/862; B29C 47/864; B29C 2793/0027; B29C 2793/009; B29K 2995/0015; B29K 2995/0013

(57) ABSTRACT

An embodiment of the invention relates to an apparatus for manufacturing particles, wherein the apparatus comprises a supply unit adapted for supplying a viscous raw material, a perforated body having a plurality of perforations and arranged to receive the viscous raw material from the supply unit to flow through the plurality of perforations, and a cutter arranged so that the viscous raw material flowing out of the plurality of perforations is cut into the particles by the cutter, wherein the apparatus is configured so that, during manufacturing the particles, a temperature of at least a portion of the perforated body is lower than a temperature of the viscous raw material flowing through the plurality of perforations, wherein the perforated body and the cutter are arranged relative to one another such that the cutter is cooled by thermal exchange with the perforated body during operation of the apparatus.

### CROSS-REFERENCED TO RELATED APPLICATION(S)

This application is a National Phase Patent Application and claims priority to and the benefit of International Application Number PCT/EP2014/067449, filed on Aug. 14, 2014, which claims priority to and the benefit of GB Patent Application No. 1314583.4, filed Aug. 14, 2013, the entire contents of all of which are incorporated herein by reference.

### FIELD OF THE INVENTION

An embodiment of the invention relates to an apparatus for manufacturing particles.

Moreover, a further embodiment of the invention relates to a method of manufacturing particles.

Furthermore, another embodiment of the invention relates to a method of use.

### TECHNOLOGICAL BACKGROUND

Hot Die Face Pelletizing is a method by which continuous extrudate strands are cut in a flowable state by oscillating or rotating cutters into pieces, wherein the cutter can be pressed towards the extrusion die plate (such as a perforated body) or can be maintained with a gap in between. The cutting procedure takes place in a cutting chamber which is cooled by a flow of a cooling medium. The extrudate pieces separated by the cutter can subsequently be transported away by means of the cooling medium, are cooled and solidified during the transport. The possibility to produce round granulate particles is a significant advantage when processing the raw material above its solidifying temperature. In the flowable state of the droplets there is an interaction between viscosity forces and surface forces which may results in the formation of spherical granulate particles.

A variety of systems for manufacturing granulate particles is available commercially. Some of these systems relate to underwater pelletizing, such as the commercially available system Sphero® of Automatik Plastics Machinery GmbH. The heat management of this system is adjusted by the transport water flowing through the cutting chamber. This results in a low surface temperature of the perforated body, the cutter and the extrudated material. Furthermore, sticky properties of the raw material are reduced which allows for the processing of sticky substances. Moreover, systems are available which are not flooded entirely with water, for instance water-ring-granulators in which a liquid film at the perforated body accomplishes the cooling, or systems in which water is sprayed into the cutting chamber.

The use of a liquid coolant results in problems when processing substances which are soluble in the cooling medium, as occurs with water as cooling medium in the pharmaceutical industry, in dietary supplement industry and in food industry. Additionally, the use of liquid cooling agents requires additional processing steps for separating the transport medium, the subsequent drying of the granulate, and the conditioning of the liquid in case of recycling.

A commercially available Hot Die Face Pelletizing apparatus, in which the cutting chamber is cooled with air, is the Sphero®-THA of Automatik Plastics Machinery GmbH. Air cooled systems obtain, due to a small heat capacitance as well as a small mass flow, only a small heat transport compared to underwater granulating systems. Thus, commercially available systems are only applicable to a very limited extent for granulating of sticky substances. Other systems are the Micro Pelletizer of LEISTRITZ GmbH or the centric granulating systems of Coperion GmbH.

U.S. Pat. No. 4,678,423 discloses a die which includes a body provided with a plurality of polymer flow channels and a plate fixed to the front surface of the body and bored at locations corresponding to each channel. An insulating layer is positioned between the body and the bored plate. The channels include a thermoregulating system for the die body. A plurality of nozzles is provided, with the nozzles being rooted inside the die body at locations corresponding to the channels. The nozzles protrude from the body itself to cross through the insulating layer and the bored plate.

WO 2012/095125 A1 discloses a granulating device for thermoplastic plastic material, which device comprises a perforated body comprising nozzle openings, wherein at least one side of the perforated body comprises in at least one region a functional layer. Said functional layer is thermally insulated in relation to the base material of the perforated body, is more abrasion-resistant relative to the base material of the perforated body and consists of an enamel coating.

CN 102 873 784 A discloses a plastic granulating device. The plastic granulating device may be characterized by comprising an extrusion disc and a cutting knife. The extrusion disc is arranged at the discharge hole end of a plastic extruder. The extrusion disc is provided with holes of which the diameters are as same as those of required plastic granules, and the cutting knife is attached to the surface of the extrusion disc and rotates on the surface of the extrusion disc, and a cooling device is arranged on the extrusion disc. Preferably, the revolving speed of the cutting knife is adjustable. Through the device, plastic extruded by the screw extruder can be quickly cooled, cut and granulated, and the lengths of the granules are adjustable, and the device is simple in structure, convenient to maintain and replace and low in machining cost.

U.S. Pat. No. 5,814,350 A relates to a hot-cut pelletizer for thermoplastics, having a housing which is designed as a hollow rotational body and the interior space of which is supplied with polymer melt, which is forced through channels passing radially through the housing wall and is cut into pellets by cutters which rotate in a substantially water-free space and slide over the openings of the channels along a cutting face running around the housing wall. The housing wall is surrounded by a ring of stationary cooling water nozzles, which direct cooling water jets onto the cutters in the manner of a jacket over the cutting face at such a small radial distance from the latter that the polymer melt is thereby chilled directly after leaving the cutting face and at the same time the cutters are cooled up to the cutting edges by the cooling water with the pellets being flung out radially.

### SUMMARY OF THE INVENTION

There may be a need for providing an efficient way of manufacturing particles from a viscous raw material.

In order to achieve the need defined above, an apparatus for manufacturing particles, a method of manufacturing particles, and a method of use according to the independent claims are provided.

According to an exemplary embodiment of the invention, an apparatus (such as a granulating device) for manufacturing particles (such as granulate) is provided, wherein the apparatus comprises a supply unit (such as an extruder) adapted for supplying a viscous raw material (such as sticky extrudate, like a polymer or thermoplast), a perforated body (such as a perforated plate, for instance an extrusion die plate) having a plurality of perforations and arranged to receive the viscous raw material from the supply unit to flow through the plurality of perforations, and a cutter arranged so that the viscous raw material flowing out of the plurality of perforations is cut into the particles by the cutter, wherein the apparatus is configured so that, during manufacturing the particles, a temperature of at least a portion (particularly at least 20%, more particularly at least 50% of a working surface of the perforated body facing the cutter) of the perforated body is lower than a temperature of the viscous raw material flowing through the plurality of perforations, wherein the perforated body and the cutter are arranged relative to one another such that the cutter is cooled by thermal exchange (particularly by direct heat exchange, more particularly by heat conduction, even more particularly by heat conduction via a direct physical contact between the perforated body and the cutter) with the perforated body.

According to another exemplary embodiment of the invention, a method of manufacturing particles is provided, wherein the method comprises guiding (particularly sticky) viscous raw material through a plurality of perforations of a perforated body so that the viscous raw material flows through the plurality of perforations, cutting the viscous raw material flowing out of the plurality of perforations into the particles by a cutter, and, during manufacturing the particles, adjusting a temperature of at least a portion of the perforated body to be lower than a temperature of the viscous raw material flowing through the plurality of perforations, and arranging the perforated body and the cutter relative to one another such that the cutter is cooled by thermal exchange with the perforated body.

According to still another exemplary embodiment of the invention, an apparatus having the above mentioned features or a manufacturing method having the above mentioned features is used for manufacturing particles selected from a group consisting of food particles, plastic particles, dietary supplement particles, and pharmaceutical particles.

According to an exemplary embodiment, the manufacturability of particles from a viscous or liquid raw material is significantly improved by adjusting a temperature of the perforated body to be lower than a temperature of the viscous or liquid raw material, thereby thermally decoupling at least a part of the perforated body from the raw material. Consequently, not only the perforated body is rendered relatively cool, but also the cutter being brought in thermal interaction with the perforated body is cooled as well by the perforated body. This thermal management prevents the raw material, even when having sticky properties, from adhering to the perforated body and/or the cutter. Consequently, the production of granulate-like particles, even on the basis of a sticky raw material, becomes possible. Hot strands of viscous raw material flow out of a cold perforated body.

In the following, further exemplary embodiments of the apparatus, the manufacturing method and the method of use will be explained.

In an embodiment, the temperature of the raw material, while being processed within the apparatus upstream of the cutter, is in the range between 50° C. and 600° C., particularly between 60° C. and 300° C.

In an embodiment, the temperature of a working surface of the perforated body in functional interaction with the cutter, is in the range between 5° C. and 100° C., particularly between 10° C. and 40° C.

In an embodiment, the temperature of a cutting edge of the cutter cutting the raw material into the particles, is in the range between 5° C. and 100° C., particularly between 10° C. and 40° C.

Any thermally conductive material mentioned in this specification may particularly have a value of the thermal conductivity of at least 15 W/Km, particularly of at least 100 W/Km. For instance, thermally conductive materials are copper or aluminum or iron.

Any thermally insulating material mentioned in this specification may particularly have a value of the thermal conductivity of less than 5 W/Km, particularly of at maximum 1 W/Km. For instance, thermally insulating materials are plastic or stone or porcelain.

An exemplary embodiment of the invention accomplishes dry and hot melt pelletizing of sticky materials with a thermally decoupled extrusion die plate.

In an embodiment, the perforated body is thermally decoupled from the supply unit, particularly by a thermally insulating structure separating the perforated body from the supply unit or by a sufficient spatial distance between the perforated body and the supply unit. In other words, the heat management of the perforated body (such as a die extrusion plate) and the heat management of the supply unit (such as an extruder) may be separated. Thus, the requirements of sufficiently heating the viscous raw material in the supply unit (so as to be flowable and therefore extrudable) on the one hand as well as the requirements of the perforated body (i.e. to enable the cutter to cut the viscous material leaving the perforated body without undesired adhesion on the cutter and/or on the perforated body) may be both met at the same time. Furthermore, a separate adjustment of the temperatures at the supply unit and at the perforated body may then be possible. In one embodiment, such as thermal separation may be accomplished by providing a thermally insulating structure between the supply unit and the perforated body which disables or at least largely suppresses a heat flow between supply unit and perforated body. In another embodiment, separated temperature adjustment units may be provided at supply unit and perforated body. In still another embodiment, the supply unit and the perforated body are located remotely from one another with such a distance in between that no mentionable heat flow occurs between the supply unit and the perforated plate.

In an embodiment, the apparatus comprises a heating unit integrated in the thermally insulating structure and configured for heating the raw material when flowing through a connection channel within the thermally insulating structure. For example, an annular heater may be provided which surrounds the connection channel and which, for instance, may be configured as an electric heating wire. Thus, direct heating of the viscous raw material within the thermally insulating structure is made possible without an undesired temperature increase of the perforated body. However, it is optionally possible to couple the thermo management of the supply unit and/or flow channel adapter with the connection channel and the nozzle inserts (thermally decoupled from the perforated plate). Furthermore, the flow channel adapter, the connection channel and/or nozzle can be taken together to one part. Moreover, the connection channel and nozzle can be taken together to one part.

In an embodiment, at least a part of the plurality of perforations is filled with a respective thermally insulating sleeve having a through hole. Thus, an undesired heat flow from the hot viscous raw material or flow channel to the perforated body can be suppressed or eliminated by the thermally insulating sleeve which may at least partially form part of the above-mentioned thermally insulating structure. However, the thermally insulating structure may additionally include also a plate-like structure which may be sandwiched between the supply unit in the perforated body.

In an embodiment, at least a part of the through holes of the thermally insulating sleeves are filled with a thermally conductive tube of the supply unit being thermally insulated from the perforated body by the thermally insulating sleeves and having a raw material supply channel for supplying the raw material to the cutter. The thermally insulating sleeves make concentrically surround the thermally conductive tubes so that the viscous raw material can be efficiently heated by the thermally conductive tubes (which may be in thermal exchange with a heater and/or the supply unit) while this heat may be prevented from passing towards the perforated body.

In an embodiment, at least a part of the thermally insulating sleeves and/or at least a part of the thermally conductive tubes has a tapering end facing the cutter. The tapering ends may flush with a working surface of the perforated body to thereby form together a planar surface facing the cutter. In view of the taper, the viscous raw material may be forced to be pressed out with a small diameter at an end face of the perforated body so that the thermally insulating sleeve and the thermally conductive tubes may also contribute to the formation of small-sized particles such as granulate.

In an embodiment, the apparatus comprises a temperature adjustment unit configured for adjusting a temperature of at least a part of the supply unit without adjusting a temperature of the perforated body. Therefore, the heating effect of this temperature adjustment unit may be limited to the supply unit while being configured so that it does not have a thermal impact on the perforated body. This keeps the raw material in a processible phase while preventing the perforated body from being brought to an elevated temperature at which raw material tends to adhere to the working surface thereof.

In an embodiment, the temperature adjustment unit is configured for adjusting the temperature of the supply unit so that the raw material is prevented from falling below (for instance from being cooled below) a solidification temperature of the raw material, particularly from solidifying, before being cut by the cutter. A solidification of the raw material occurs when it is transferred from a flowable or liquid phase to a solid phase. Therefore, the raw material may be maintained in the viscous or liquid state before leaving the perforated body. In an embodiment, the apparatus comprises a cooling unit configured for cooling the perforated body. For instance, it is possible to cool the entire perforated body. However, it may also be sufficient to cool selectively only those sections or spatial portions of the perforated body which are spatially close to the perforations and are therefore prone to undesired adhesion of raw material on such surface portions. Also those surface portions of the perforated body can be cooled which are passed by the cutting element(s) of the cutter during the cutting procedure, to thereby maintain a cooling of the cutter for preventing adhesion of raw material at the cutter.

In an embodiment, the cooling unit is configured for cooling the perforated body to such a temperature that the raw material is prevented from adhering to the perforated body and the cutter upon cutting. Particularly, the perforated body and the cutter may be arranged relative to one another such that the cutter is cooled by thermal exchange with the cooled perforated body. When the perforated body is actively cooled, the perforated body, and via heat exchange between perforated body and cutter also the cutter, can be brought to a relatively low temperature (for instance below the solidifying temperature of the raw material) which suppresses adhesion of the raw material on perforated body and cutter and therefore makes it possible to process even sticky raw material (such as polymers used for pharmaceutical applications) with an apparatus according to an exemplary embodiment of the invention.

In an embodiment, the apparatus is configured so that, during manufacturing the particles, the temperature of at least a working surface, particularly a planar working surface, more particularly an annular planar working surface, of the perforated body facing the and cooperating with the cutter and surrounding the perforations is lower than the temperature of the viscous raw material flowing through the plurality of perforations, particularly is below a solidification transition temperature of the raw material. By selectively maintaining the surface portion of the perforated body cooperating with the cutter during the cutting procedure cool, a self-sufficient cooling of the cutter during carrying out the cutting procedure can be obtained.

More particularly, the working surface may be made of a thermally conductive material, thereby further promoting thermal exchange between perforated body and cutter. Thus, the surface material of the working surface itself may be selected so that an efficient cooling of the cutter is obtained.

In an embodiment, the perforated body and the cutter may be arranged relatively to one another such that the cutter is in direct physical contact with a working surface of the perforated body during cutting. With such a direct mechanical connection between working surface of perforated body and cutter, an efficient flow of thermal energy between perforated body and cutter is enabled, thereby cooling the cutter when the perforated body is cooled, or vice versa.

Alternatively, the perforated body and the cutter may be arranged relatively to one another such that the cutter is spaced by a gap with regard to a working surface of the perforated body, which gap has such a small width, particularly a width of less than approximately 1 mm, that temperature equilibration between the perforated body and the cutter occurs by a thermal exchange (particularly by heat convection) during cutting. Therefore, the spatial arrangement of perforated body and cutter relative to one another may be so close that both can be considered as a common, thermally coupled system so that the temperature change of one of the perforated body and the cutter results in a corresponding temperature change of the other one of the perforated body and the cutter. In case of a gap between perforated plate and cutter, advantageously no friction heating occurs. However, it is optionally possible to actively cool the perforated plate and/or the cutter by an assigned cooling unit (for instance in the form of integrated cooling channels and/or heat pipes and/or Peltier coolers) of the perforated plate and/or of the cutter.

In an embodiment, the apparatus comprises a flow channel adapter arranged for continuously transforming a flow profile of the raw material from a profile adapted to the supply unit to a profile adapted to the perforated body. Particularly, the profile adapted to the supply unit may have an 8-shaped cross-section and/or the profile adapted to the perforated body may have a circular cross-section. For example, the supply unit may be configured as a double screw extruder having two interacting screws for mixing and conveying the raw material towards the perforated body. An outlet of such a supply unit may correspondingly have a substantially 8-shaped profile. On the other hand, a conduction channel supplying the raw material to the perforated body may have a substantially or 0-shaped or circular profile. The flow channel adapter has an internal shape to provide form adjustment between the 8-shaped profile and the circular profile. The flow channel adapter may be made of a thermally conductive material.

In an embodiment, the apparatus comprises a heating unit configured for heating the flow channel adapter to prevent the raw material flowing through the flow channel adapter from falling below a solidification temperature of the raw material, particularly from solidifying. While the raw material passes through the flow channel adapter, its conversion into a solid phase should be prevented, which can be safely accomplished by heating the raw material while passing through this intermediate piece.

In an embodiment, at least a part of raw material outlets of the plurality of perforations of the perforated body has a diameter which is smaller than a length of a cutting edge of a cutting element of the cutter for cutting raw material exiting via a corresponding raw material outlet to thereby manufacture a particle. When the dimension of the raw material leaving a perforation is significantly smaller than a dimension of a cutting element (such as a blade) of the cutter cutting the strand of raw material into the particles, the heat transfer from the raw material to the cutting element may be maintained sufficiently small so as to prevent undesired adhesion of the raw material at the cutting element. In other words, the heat transfer from such a small dimensioned strand to the significantly larger dimensioned cutting element is then neglectable.

In an embodiment, the apparatus comprises a housing and a thermally conductive sealing, wherein a flange face of the perforated body is mounted to the housing with the sealing in between. The housing or casing may define an exterior shape and shell of the apparatus. The interface between the housing and the perforated body should be sealed so as to prevent undesired flow of material and/or heat from an interior to an exterior of the apparatus, or vice versa. However, in still another exemplary embodiment, the sealing can be omitted at all.

In an embodiment, the apparatus comprises a cooling unit configured for cooling the sealing. When the sealing is actively cooled, the thermal decoupling between the exterior and interior of the housing can be strengthened and additionally a cooling of the perforated body may be accomplished or supported. In an embodiment, the cutter is configured as one of the group consisting of an oscillating cutter and a rotating cutter. For instance, the cutter may comprise several circumferentially aligned cutting elements having sharp blades which, upon rotating the cutter, continuously cut pieces of the strands of raw material protruding over the perforations into the particles. Alternatively, one or more cutting elements may reciprocate so as to cut particles from the strands of raw material during the reciprocation.

In an embodiment, the supply unit is configured as an extruder, particularly a twin-screw extruder. However, it is also possible to implement the apparatus with other kind of supply units pre-processing the raw material before cutting it into the individual particles.

In an embodiment, at least approximately 20%, particularly at least approximately 50%, more particularly at least approximately 70%, even more particularly at least approximately 85%, of an area of a working surface, particular of an annular working surface, of the perforated body facing the cutter (for instance contacted by the cutter during cutting or being spaced from the cutter by only a very small gap during cutting) has a temperature which is lower (for instance at least 10° C. lower, particularly at least 50° C. lower) than the temperature of the viscous raw material flowing through the plurality of perforations. In an embodiment, the only portions of the working surface of the perforated body being at a higher temperature are (for instance circular) sections including and surrounding the perforations.

In an embodiment, the temperature of at least the portion of the perforated body is adjusted to be lower than a solidification temperature of the viscous raw material. When the temperature of the raw material assumes an undesired value, the cutting performance can be negatively influenced, for instance undesired adhesion of raw material at the cutter and/or at the perforated body may occur.

In an embodiment, food particles, plastic particles, dietary supplement particles and/or pharmaceutical particles may be manufactured. In all these fields, there is a need to process sticky raw material. By the thermal management according to exemplary embodiments, the thermal separation of a supply unit from a cooler perforated body/cutter arrangement renders the processing of sticky raw materials feasible. Thus, for instance pelletizing of a sticky pharmaceutical molten mass (such as Soluplus® from BASF AG) becomes possible when keeping the perforated body and the cutter at a sufficiently low temperature. In the field of pharmaceutical processing, the pharmaceutical raw material may be forced through small perforations (which may for instance have a diameter between 0.1 mm and 2 mm, for example 1 mm), may be cut into small particles such as a granulate or pellets, and may be further processed (for instance, the manufactured particles may be filled into a capsule). In food industry, one application of the manufacturing concept according to an embodiment of the invention is the manufacture of instant products, for example instant granulate, such as instant coffee.

In an embodiment, the perforations may be arranged symmetrically along or over the perforated plate. However, it is also possible that the perforations are arranged in any asymmetric pattern along or over the perforated plate, particularly in each axial and/or radial combination. Their mutual distances may be identical or different.

In an embodiment, the thermally insulating structure may comprise at least one cooling unit configured for actively cooling the perforated plate. Such a cooling unit may be a Peltier cooler, a liquid cooling device, etc.

In an embodiment, a single thermally insulating structure may be provided. However, it is alternatively also possible to provide two, three or more thermally insulating structures.

In an embodiment, the cutter may be an ordinary cutter as used in the art of Hot Die Face Pelletizing. It is possible that the cutter comprises subdivided sections or is zoned. For example, it is possible to provide the cutter with grooves so that the locations of the sharp cutting elements are limited to the positions on the perforated plate at which the raw material strands leave the perforations.

The aspects defined above and further aspects of the embodiment of the invention are apparent from the examples of embodiment to be described hereinafter and are explained with reference to these examples of embodiment.

### DESCRIPTION OF THE DRAWINGS

An embodiment of the invention will be described in more detail hereinafter with reference to examples of embodiment but to which the embodiment of the invention is not limited.

FIG. 1 illustrates a schematic view of an apparatus for manufacturing particles according to an exemplary embodiment of the invention.

FIG. 2 shows a cross-section of a perforated plate thermally decoupled from a supply unit and cooperating with a juxtaposed cutter of an apparatus for manufacturing particles according to an exemplary embodiment of the invention.

FIG. 3 shows a cross-section of another perforated plate thermally decoupled from a supply unit and cooperating with a juxtaposed cutter of an apparatus for manufacturing particles according to another exemplary embodiment of the invention.

FIG. 4 illustrates the temperature profile at a transition between extrudate and a cutter of an apparatus for manufacturing particles.

FIG. 5 illustrates a schematic view of a conventional apparatus for manufacturing particles.

FIG. 6 is a side view illustrating a mechanical and thermal interaction between a perforated plate and a cutter caused by friction.

FIG. 7 is a plan view of an annular working surface section of a perforated plate showing eight circumferentially distributed perforations with locally higher temperature as compared to adjacent working surface portions of the perforated plate.

FIG. 8 schematically illustrates a temperature distribution along a circumference of a working surface of a perforated plate during one rotation of a cutter cooperating with the perforated plate having eight perforations.

FIG. 9 shows a temperature profile of a perforated plate with conventional heat coupling with a supply unit (left image, “A”) and a temperature profile of a perforated plate being thermally decoupled from the supply unit according to an exemplary embodiment of the invention (right image, “B”).

FIG. 10A shows a three-dimensional view of a conventionally shaped cutter for implementation in an apparatus for manufacturing particles according to an exemplary embodiment of the invention and being cooled to such a low temperature that no adhesion of sticky viscous raw material takes place.

FIG. 10B shows a three-dimensional view of a cutter being implemented in a conventional apparatus for manufacturing particles and being at such a high temperature that adhesion of sticky viscous raw material takes place.

FIG. 11 is a schematic illustration of an apparatus for manufacturing particles according to another exemplary embodiment of the invention.

FIG. 12 shows a cross-sectional view of a thermally conductive tube being surrounded by a thermally insulating sleeve and both being inserted into a perforation of a perforated plate of an apparatus for manufacturing particles according to an exemplary embodiment of the invention.

FIG. 13 shows a three-dimensional view of the arrangement of thermally conductive tube and thermally insulating sleeve of FIG. 12.

The illustrations in the drawings are schematical. In different drawings, similar or identical elements are provided with the same reference signs.

### DETAILED DESCRIPTION OF EXEMPLARY EMBODIMENTS

Before specific exemplary embodiments of the invention will be described referring to the drawings, some basic considerations of the present inventors will be summarized based on which exemplary embodiments of the invention have been developed.

Sticky substances such as molten polymers tend to wet surfaces in the liquid state and form adhesion forces with regard to a contact area as a consequence thereof. The amount of wetting depends on the contact temperature. In the case of pelletizing this is the temperature between cutter and working surface with the extrudate. Due to the heat transport a contact temperature will be present at the contact surface. It depends on the thermal properties and the core temperature of the materials. When the contact temperature is above the solidifying temperature of the extrudate, the material at the contact surface can flow into voids in the rough surface and can therefore form adhesion forces. The time required for the flow into the micro voids depends on the present viscosity: the procedure is the faster, the lower the viscosity of the substance is. At a contact temperature below the solidifying temperature, the material is in the solid phase at the contact surface and can generate only very small adhesion forces as a result of the few contact points of the surface on a microscopic scale. It is therefore believed that the heat management in the cutter chamber is highly relevant, if not decisive, for the processability of sticky substances.

An exemplary embodiment of the invention is based on the recognition that an appropriate tempering of a working surface of a perforated plate as well as of a cutter contacting the or closely spaced to the working surface of the perforated plate can ensure that the surface's temperatures remain below the solidification temperature of the extrudated material so as to prevent undesired adhesion of the extrudate material at these surfaces. An exception of this tempering rule is the region of the perforated plate directly at an outlet of a capillary through which the extrudate flows within the perforated plate. This region shall be maintained by a corresponding heat management above the solidification temperature of the extrudate, in order to allow for a processability of the extrudate at appropriate pressure values and without the danger of an occlusion of the perforations by solidifying extrudate material. A channel through which the extrudate material flows can be (at least section-wise) correspondingly heated and can be additionally thermally isolated (by implementing thermally insulating materials) from the perforated plate, more particularly at least from the working surface of the perforated plate. An active cooling of the working surface of the perforated plate can be performed by cooling channels (which may be integrated within the perforated plate or arranged on the perforated plate) through which a cooling liquid can be conducted. The cutter may be pressed with direct physical contact onto the working surface of the perforated plate (or may alternatively be maintained at an extremely small distance with regard to the perforated plate so that an efficient thermal exchange (for instance by heat convection) between perforated plate and cutter is still possible) and can carry out an oscillating or rotating motion. Via the working surface, efficient heat conduction between cutter and perforated place is triggered. The cutter may be located most of the time in direct contact with cold portions of the contact surface, and only during cutting granulate from the solidifying raw material directly at an outlet opening of a perforation a slight heat transition from the capillary into the cutter may take place. An appropriate ratio between cool sections and hot sections on the working surface shall be selected in order to reduce or minimize a heating of the cutter and of the working surface. Upon pressing the cutter onto the working surface of the perforated plate, some additional friction heat may be generated. This friction heat can be transported directly into the perforated plate (which then serves as a heat sink) so as to prevent heating of the cutter above the solidification temperature of the raw material at any time during operation of the apparatus.

According to an exemplary embodiment, an architecture is provided which allows to increase the process window of dry pelletizing systems in terms of enabling manufacturability of particles from sticky substances. This is achieved by configuring the heat management of the supply unit for supplying the sticky raw material to be independently of the heat management of a perforated plate with perforations through which the sticky raw material is pressed directly before cutting.

According to an exemplary embodiment, it is furthermore possible to use air or another gas, or sublimating substances (such as dry ice) or combinations of the mentioned agents as a cooling medium in the cutting chamber to obtain a dry processing apparatus. Whenever a cooling unit is mentioned within this application, it can also be realized by the use of sublimating substances (such as dry ice). The before mentioned dry processing apparatus may prevent any undesired dissolution of soluble substances (for instance of active pharmaceutical ingredients, water soluble polymers or products from food industry) in water or another liquid coolant, as may occur in conventional liquid cooled cutting chambers. Exemplary embodiments of the invention also increase the freedom of design as a result of a decentralization of the heat management system. For instance, this allows for a balancing or equilibration of the heat expansion at a downstream portion of the apparatus, so that exemplary embodiments of the invention do not necessarily require identical thermal expansion coefficients of the used materials. Moreover, the thermal load or heat impact of the raw material can be adjusted more precisely, since the temperature can be controlled with a smaller gradient up to the outlet opening of the perforated plate. One advantageous aspect of an embodiment of the invention is a selective thermal management of perforated plate and flow channel. Another advantageous aspect is the cooling of the pelletizing apparatus by heat conduction via the working surface of the perforated plate facing the cutter. Another advantageous aspect is that anti tacking agent as ingredient of a formulation is required to a lesser extent or even not at all.

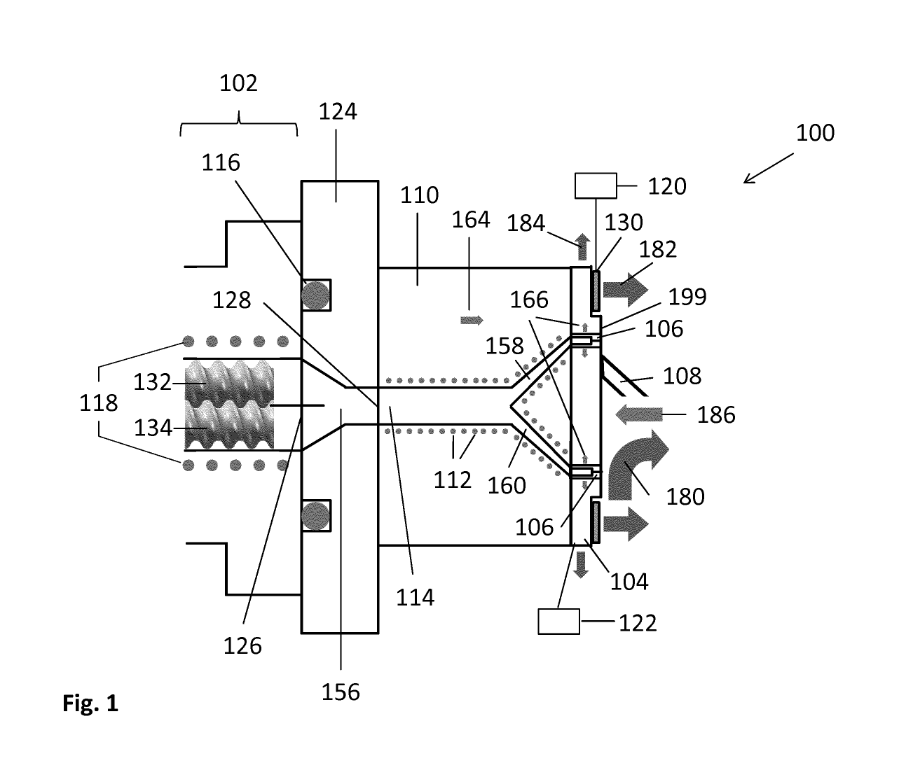

FIG. 1 illustrates a schematic view of an apparatus 100 for manufacturing particles according to an exemplary embodiment of the invention.

As can be taken from FIG. 1, the apparatus 100 comprises a supply unit 102 which is here configured as a double screw extruder or twin screw extruder having a first screw 132 intermeshing with a second screw 134 for mixing and transporting a viscous and sticky raw material such as a molten polymer used as a carrier or matrix for embedding an active pharmaceutical ingredient therein. The raw material is processed within the supply unit 102 in a flow channel having a substantially 8-shaped cross-section 126. As can furthermore be taken from FIG. 1, a heating unit 118 which can be configured for providing an ohmic heating is arranged to circumferentially surround the flow channel of the supply unit 102. The heating unit 118 is located in such a manner within the supply unit 102 so that it thermally impacts exclusively the supply unit 102 and the raw material flowing therethrough without having any thermal impact on a perforated plate 104 arranged downstream of the supply unit 102 which will be described below in more detail.

Directly adjacent to the supply unit 102 and arranged downstream thereof is a flow channel adapter 124 made of a thermally conductive material. The flow channel adapter 124 is arranged for continuously transforming a flow profile of the raw material from the substantially 8-shaped flow profile 126 in the supply unit 102 into a circular flow profile 128 at an entrance of a thermally insulating structure 110 sandwiched between the flow channel adapter 124 and the perforated plate 104 and thermally decoupling the flow channel adapter 124 (and the supply unit 102) with regard to the perforated plate 104. A further heating unit 116, which can also be embodied as an electric heating, is integrated within the flow channel adapter 124 to thereby heat the flow channel adapter 124 and, in turn, the sticky raw material flowing through an internal channel 156 of the flow channel adapter 124.

After having passed the circular flow profile 128, the viscous raw material flows into a connection channel 114 formed as a circular cylindrical lumen within the thermally insulating structure 110. The thermally insulating structure 110 is manufactured of a thermally insulating material which prevents, apart from a very small contribution from heat conduction, as indicated by reference numeral 164, any mentionable heat exchange between the supply unit 102 or the flow adapter 124 and the perforated plate 104. In order to maintain the liquid or viscous flowable raw material in the flowable state while passing the connection channel 114, still another heating unit 112 is arranged circumferentially around the connection channel 114. In the shown embodiment, the connection channel 114 is bifurcated and is split into several partial channels 158, 160 directing the raw material towards various perforations 106 of the perforated plate 104. Also the heating unit 112 can be configured to provide for an electric heating such as an ohmic heating or fluid heating.

By the heating units 118, 116, 112 it can be ensured that the raw material is prevented from solidifying along the entire flow path from the supply unit 102 via the flow channel adapter 124 and the thermally insulating structure 110 towards the perforated plate 104.

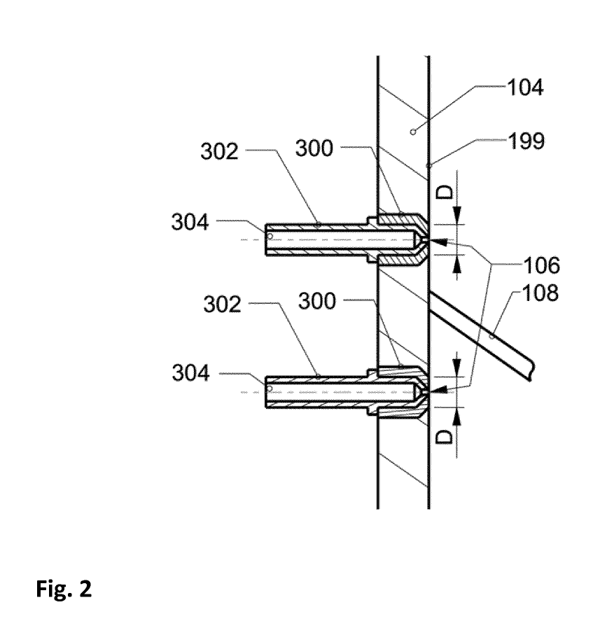

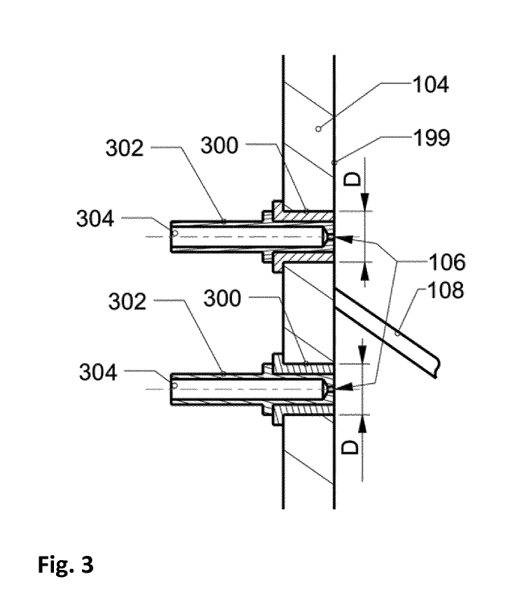

The perforated plate 104 has the plurality of perforations 106 which are arranged to receive therein the sticky raw material from the supply unit 102 via the flow channel adapter 124 and the thermally insulating structure 110. The raw material then flows through each of the perforations 106. Only during the very short through flow path of the raw material through the perforations 106, a slight heat exchange between the hot raw material and the cool perforated plate 104 is possible, as indicated by reference numeral 166. Optionally, this minor heat exchange can be further suppressed or even eliminated by arranging a thermally insulating sleeve within the perforations 106 (compare the embodiments of FIG. 2 or FIG. 3). However, in an alternative embodiment, already the thermal decoupling effect of the thermally insulating structure 110 may be enough to keep the perforated plate 104 significantly cooler than the part of the apparatus 100 located upstream of the thermally insulating structure 110.

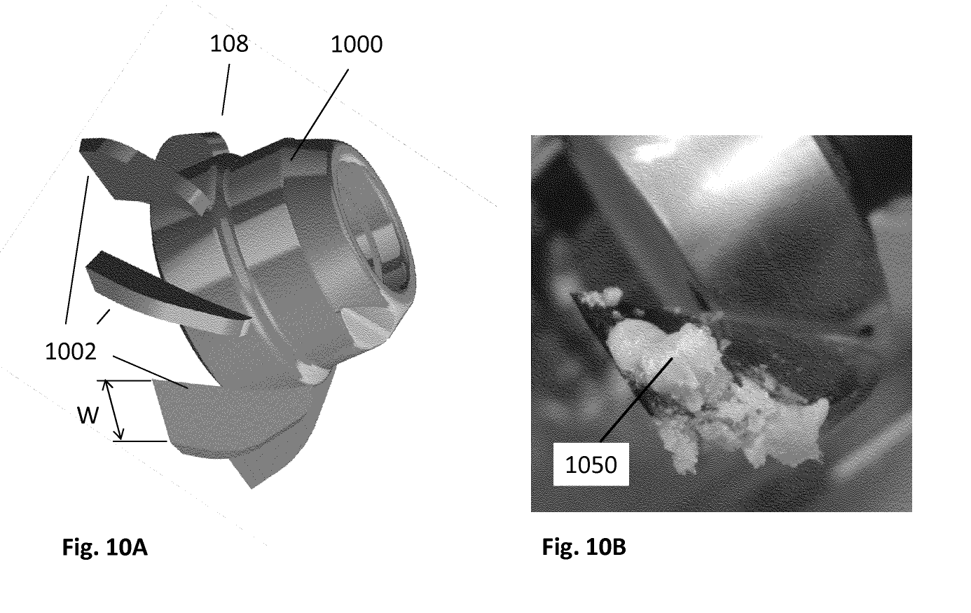

A cutter 108 (which is only shown schematically in FIG. 1 and in more detail in FIG. 10A) is arranged downstream of the perforated plate 104 and may slidingly rotate with a direct physical contact to the perforated plate 104 (or with a very small gap in between still ensuring a proper heat conductive coupling between cutter 108 and perforated plate 104) so as to continuously cut off individual particles such as granulate from the strands of raw material protruding over the perforations 106 at a working surface 199 of the perforated plate 104 facing the cutter 108. Slightly before, during and/or after the cutting procedure, the raw material solidifies at the boundary with the working surface 199. The bulk is still viscous, so that the particles can deform after cutting to spherical particles.

In view of the thermal management as described above, a temperature of the majority of the perforated plate 104 (particularly its working surface 199) remains continuously below a temperature of the flowable raw material flowing through the plurality of perforations 106. At the same time, the direct contact or close spatial relationship between the cutter 108 and the working surface of the perforated plate 104 continuously cools the cutter 108 during operation by heat conduction as a result of the low temperature of the perforated plate 104. This prevents the sticky raw material from adhering in an undesired manner on the contact surface of the perforated plate 104 and, even more important, on a surface of the cutter 108. Furthermore, it has the advantage that the process stability of supply unit 102 is almost independent of the cutter 108.

In the shown embodiment, a cooling unit 122 is provided which is configured for actively cooling the perforated plate 104. This cooling unit 122 can be for instance a Peltier cooler or may be operated for conducting a cooling liquid such as water through separate cooling channels of the perforated plate 104.

An additional cooling of the perforated plate 104 may be accomplished by yet another cooling unit 120 which directly cools a thermally conductive sealing 130, here configured as an annular sealing ring. The sealing 130 is to be sandwiched between a flange face of the perforated plate 104 and an exterior housing of the apparatus 100 (not shown). By thermal conduction, the cooling of the sealing 130 by the cooling unit 120 also results in a cooling of the perforated plate 104. The cooling power of the cooling units 120, 122 can be adjusted so that the raw material leaving the perforations 106 before being cut by the cutter 108 is prevented from adhering to the perforated plate 104 and the cutter 108.

An insert consisting of a thermally conductive tube and an outer thermally insulating sleeve (see description of FIG. 2 and FIG. 3 for further details) can be optionally inserted into the perforations 106. By such an insert, it can be ensured that the raw material outlets of the perforations 106 of the perforated plate 104 have a diameter being smaller than a length of a cutting edge of a cutting element of the cutter 108. Therefore, in view of relatively large cutting elements and relatively small strands of raw material leaving the perforations 106, heating of the raw material as well as cooling of the perforated plate 104 can be further promoted, since these results only in a weak thermal coupling of the raw material leaving the perforated plate 104 and the cutter 108.

In addition to the described heat management, air cooling 180 may occur as well which further cools the perforated plate 104. In view of the actively cooled sealing 130, thermal conduction into the housing may occur, as indicated by reference numeral 182. By natural convection, see reference numeral 184, an additional cooling effect may take place. A small impact of cutting element friction may provide for some heating of the perforated plate 104, see reference numeral 186.

According to the embodiment of FIG. 1, the heat management of the perforated plate 104 may be characterized by a thermal separation or decoupling from the heat management of the supply unit 102, here embodied as extruder and/or the flow channel adapter 124. Just as an example and again referring to FIG. 2 and FIG. 3, this can be supported by inserting thermally insulating material into the raw material channels within the perforated plate 104. The poor thermal conductivity as a result of this thermal separation reduces or minimizes the heat conduction from the flow channel adapter 124 into the perforated plate 104. Tempering of the outlet opening can be performed with a thermally conductive nozzle insert which is heated by a heating element located adjacent to the perforated plate 104 (for instance making use of the heating unit 112).

In such a heat management arrangement, remaining heat sources are the strongly suppressed heat conduction 166 via the thermally insulated nozzle inserts as well as very small heat conduction 164 remaining regardless of the thermal separation, and the cutter friction 186. The cutter friction 186 depends on the contact pressure, the revolution speed and the friction coefficient of the materials. The required contact pressure can be maintained very small, since no adhering film of raw material is formed on the cold working surface 199 of the perforated plate 104 which, conventionally, has to be removed (under generation of thermal heat). The main heat source on the perforated plate 104 is hence the cutter friction 186 which is however reduced by the positive impact of the contact pressure by embodiments of the invention.

FIG. 2 and FIG. 3 show a cross-section of a respective perforated plate 104 thermally decoupled from a supply unit 102 (not shown) and cooperating with a juxtaposed cutter 108 of an apparatus 100 (not shown) for manufacturing particles according to an exemplary embodiment of the invention.

As can be taken from FIG. 2 and FIG. 3, the perforations 106 are each filled with a thermally insulating sleeve 300 having a through hole. In each of the through holes of the thermally insulating sleeves 300, a respective thermally conductive tube 302 is inserted which may belong to or may be thermally connected with the supply unit 102 or with an appropriate heating unit such as heating unit 112. Each of the thermally conductive tubes 302 is thermally insulated from the perforated plate 104 by a respective or assigned one of the thermally insulating sleeves 300 (optionally, also a thermal insulating structure 110 may be provided in the embodiment of FIG. 2 or FIG. 3). A raw material supply channel 304 for supplying the raw material from the supply unit 102 (not shown) to the cutter 108 is formed in an interior of each of the thermally conductive tubes 302. Moreover, as can be taken from FIG. 2, the thermally insulating sleeves 300 and the thermally conductive tubes 302 have a tapering end ending in the working surface 199 facing the cutter 108. In the embodiment of FIG. 3, only the thermally conductive tubes 302 have a tapering section close to the respective front end ending in the working surface 199 facing the cutter 108, whereas the thermally insulating sleeves 300 are hollow cylindrical without tapering front end, but having a widened back end forming a stop for abutting against the perforated plate 104. Each pair of thermally insulating sleeve 300 and thermally conductive tube 302 forms a nozzle insert for insertion into the perforations 106.

Therefore, FIG. 2 and FIG. 3 each show a thermally decoupled extrusion die plate embodied as perforated plate 104 and being configured for granulating continuously produced extrudate. The extrudate strands flow out of the perforations 106 and are cut into granulate by means of the oscillating or rotating cutter 108 which scrapes or rubs over the working surface 199 (which may also be denoted as contact surface or sliding surface) of the perforated plate 104. The cutting procedure can be carried out by processing Plowable viscous material and can be performed with the cutter 108 being pressed onto the working surface 199 of the perforated plate 104 or being spaced by a small gap with regard to the working surface 199 of the perforated plate 104. In the latter case, the gap should be small enough (for instance not more than 1 mm) so as to still enable efficient heat transfer predominantly by heat convection between the perforated plate 104 and the cutter 108.

The extrudate can be conducted through at least one temperature adjusted flow channel in form of the raw material supply channel 304 (wherein the temperature adjustment may be accomplished by electric heating, by a circulating liquid as heating medium, etc.) circumferentially delimited by a thermally conductive material, i.e. the respective thermally conductive tube 302. The thermally conductive tubes 302 are separated from the perforated plate 104 (which may be made of a thermally conductive material) by at least one layer of a thermally insulating material, i.e. thermally insulating sleeve 302. The components denoted with reference numerals 300 and 302 can be connected to one another by a form closure, force closure or by firmly bonding (such as adhering, sintering, soldering or welding). For the components denoted with reference numerals 300, 302 delimiting the raw material supply channels 304, it is advantageous to select chemically inert materials, and in case of abrasive extrudate material, abrasion-proof materials. The thermal separation between the extrudate material and the perforated plate 104 prevents an undesired solidification of the extrudate material within the raw material supply channel 304. The nozzle inserts, i.e. the members formed of components denoted with reference numerals 300 and 302, can be connected to the perforated plate 104 by a form closure, force closure or by firmly bonding.

By the thermal decoupling between the perforated plate 104 and the raw material supply channel 304, it is possible to cool the perforated plate 104 without undesired solidification of the extrudate material. Thus, an undesired adhesion of the raw material or extrudate on the working surface 199 of the perforated plate 104 can be advantageously prevented or suppressed. When the cutter 108 is pressed onto the working surface 199 of the perforated plate 104 heat conduction between the cutter 108 and the perforated plate 104 occurs in addition to the other cooling measures. The cutter 108 generates friction heat as a result of the contact with the working surface 199 of the perforated plate 104 and as a result of its motion. This heat can be transported towards the cooled perforated plate 104 serving as a heat sink. Only during the short time intervals during which the cutter 108 moves over the outlet openings of the perforations 106 at the side of the working surface 199 there is a thermal contact with a respective one of the hot raw material supply channels 304 and the components denoted with reference numerals 300, 302, and therefore heat is transferred from the hot regions into the cutter 108. Since the surface area of the openings of the raw material supply channel 304 can be selected to be much smaller than a surface area of the working surface 199, the described heat management in connection with the provision of a gaseous contact medium in the cutting chamber causes low contact temperatures of perforated plate 104 and cutter 108 during the cutting procedure of the extrudate and thereby prevents the cause for many problems in terms of pelletizing, because this prevents undesired adhesion of sticky material onto the surface is of the contact surface 199 and the cutting elements of the cutter 108.

Consequently, exemplary embodiments of the invention allow to obtain very similar temperature values for cutter 108 and perforated plate 104 and therefore allow to achieve an equivalent granulate quality as in case of underwater granulating, however without the limitation to non-soluble raw materials.

Referring again to FIG. 2 and FIG. 3, the inserts formed by the thermally insulating sleeves 300 and the thermally conductive tubes 302 have a diameter D at the working surface 199.

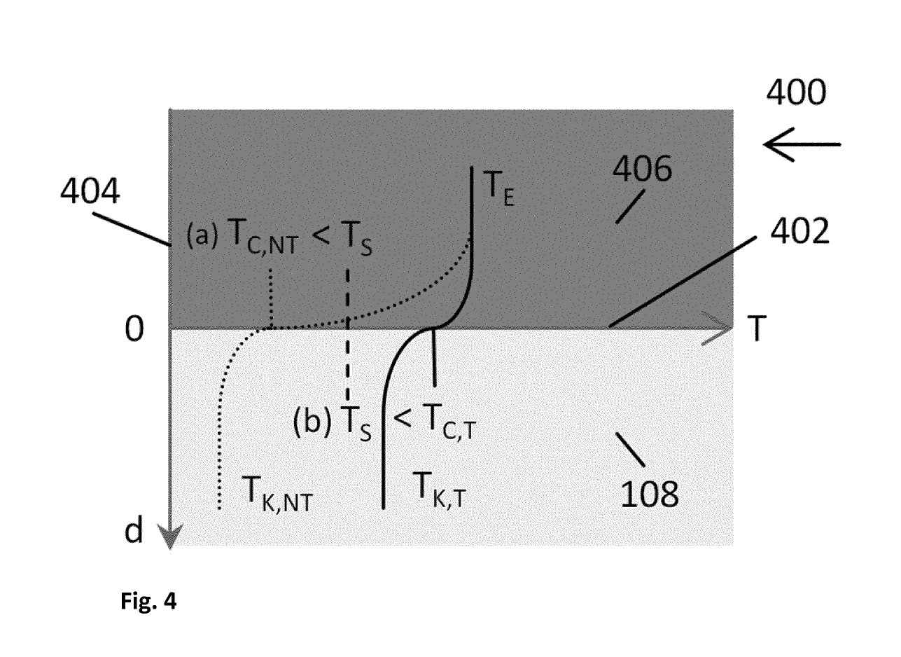

FIG. 4 illustrates a temperature profile at a thermal transition between extrudate material (compare reference numeral 406) and a cutter 108 of an apparatus 100 for manufacturing particles according to an exemplary embodiment of the invention.

More specifically, FIG. 4 illustrates a diagram 400 having an abscissa 402 along which the temperature T is plotted. Along an ordinate 404, a distance d to the contact surface between the extrudate material (d<0) and cutter 108 (d>0) is plotted.

FIG. 4 shows the temperature characteristic at the thermal transition between the extrudate 406 and the cutter 108 for a non-adhesive scenario (“(a)”, dotted line), as well as for an adhesive scenario (“(b)”, solid line). T_{S} denotes the solidification point of the extrudate 406 and is indicated as dashed line, T_{E} is the core temperature of the extrudate 406, T_{K,T} is the core temperature of the cutter 108 in an adhesive scenario, T_{K,NT} is the core temperature of the cutter 108 in the non-adhesive scenario, T_{C,T} is a contact temperature in an adhesive scenario, and T_{C,NT} is a contact temperature in the non-adhesive scenario.

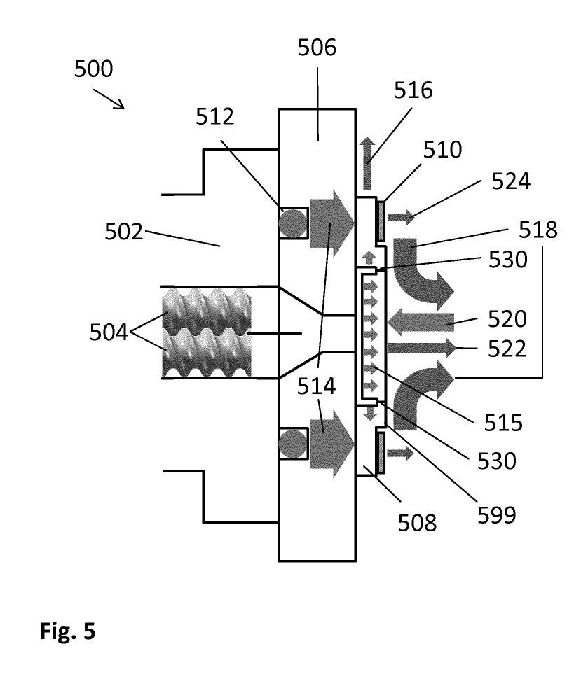

For comparison with FIG. 1, FIG. 5 illustrates a schematic view of a conventional apparatus 500 for manufacturing particles. FIG. 5 is described in order to visualize the differences in terms of thermal management as compared to the embodiment of the invention according to FIG. 1.

The apparatus 500 comprises a double screw extruder 502, wherein the two screws are denoted with reference numeral 504. A flow channel adapter 506 adjusts the profile of the flow channel between the double screw extruder 502 and a perforated plate 508 having a plurality of perforations 530. A thermally insulating sealing 510 sealingly connects the perforated plate 508 to a housing (not shown). An electric heating unit 512 heats the flow channel adapter 506 and, via intense heat conduction 514, also the perforated plate 508. Further thermal exchange between various components of the apparatus 500 and the environment is natural convection 516, air cooling 518, cutter friction 520, and heat conduction into the cutter (not shown) as denoted with reference numeral 522. The working surface 599 is the contact surface of the knife on the perforated plate 508. Furthermore, heat conduction 524 from the sealing 510 into the housing occurs.

FIG. 5 therefore shows the thermal exchange of a conventional apparatus 500 for manufacturing particles. The apparatus 500 thermally couples the heat management of the extruder 502 with the heat management of the cutter pressed onto the perforated plate 508. The flow channel adapter 506 connects the extruder 502 mechanically and thermally with the perforated plate 508 and thermally to the cutter. The flow channel adapter 506 is electrically heated by the heating unit 512 and serves as a heat source for tempering the perforated plate 508. The heat is distributed towards the working surface 599 and flow channels within the perforated plate 508 via heat conduction 515. Additionally, further heat sources impact the perforated plate 508: Firstly, the cutter pressed onto the perforated plate 508 causes cutter friction 520 and therefore friction heat. Secondly, there is heat transition between the extrudate and the perforated plate 508. Cooling sources are the natural convection 516, heat conduction 524 via the sealing 510, as well as air cooling 518 and the heat conduction into the cutter as denoted with reference numeral 522.

Coming back to FIG. 1, the apparatus 100 according to an exemplary embodiment of the invention will be discussed in further detail in the following:

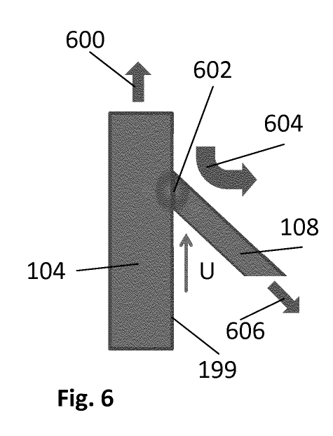

FIG. 6 is a side view illustrating a mechanical and thermal interaction between perforated plate 104 and cutter 108 on working surface 199 by friction. The main thermal exchange mechanisms are heat conduction 600, friction heat 602, convection cooling 604, and heat conduction 606 into the head of the cutter 108. In FIG. 6, the motion direction of the cutter 108 is denoted with “U”.

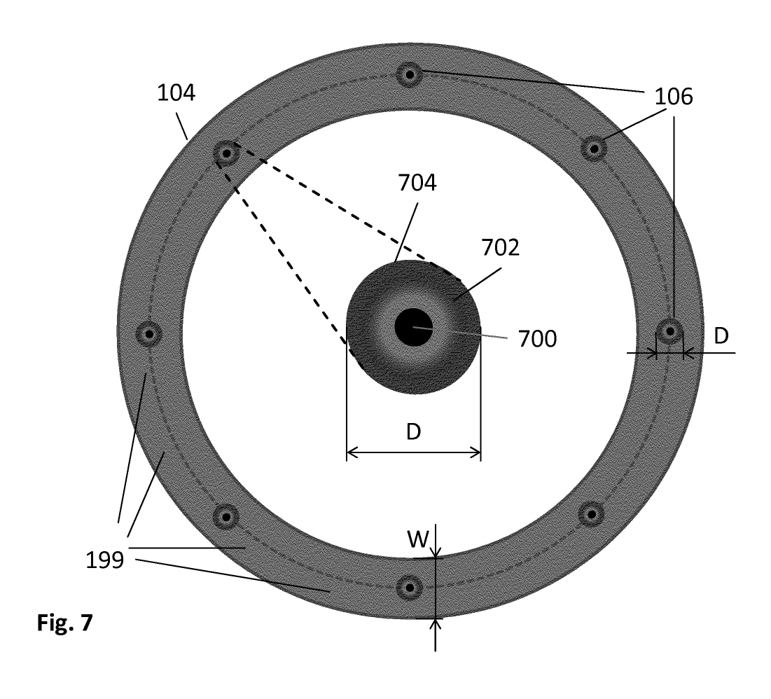

FIG. 7 is a plan view of an annular section of the perforated plate 104 showing eight circumferentially distributed perforations 106 with locally higher temperature as compared to adjacent surface portions of the working surface 199 of the perforated plate 104. FIG. 7 furthermore shows a detailed view of one of the perforations 106. The arrangement of the perforations 106 is not limited to the shown geometry. It is for instance also possible to arrange the perforations 106 at different diameters on the perforated plate 104. A central portion thereof corresponds to an outlet opening 700 via which the sticky viscous raw material flows out of the perforated plate 104 in a direction perpendicular to the paper plane of FIG. 7. The outlet opening 700 is surrounded by a small annular area 702 with a locally increased temperature (particularly above the solidification temperature of the raw material) as a result of the thermal impact of the hot raw material and the nozzle. Apart from the locally limited annular areas 702, the remaining part 704 of the working surface 199 of the perforated plate 104 (which can be more than 95% of the contact surface of the perforated plate 104) is at a low temperature, for instance continuously below the solidification temperature of the raw material.

Referring to FIG. 6 and FIG. 7, the hot raw material outlets (covering the sections denoted with reference numerals 700 and 702) of the perforations 106 of the perforated plate 104 has a diameter D which is smaller than a width W (compare also FIG. 10A) of a cutting edge of a cutting element of the cutter 108 for cutting raw material exiting via a corresponding raw material outlet.

According to the described embodiment of the invention, heat sinks are convection cooling 604 and heat conduction 600. Heat conduction 606 in the cutter 108 is only dependent on the position of the cutter 108. When the cutter 108 is only in contact with the working surface 199 of the perforated plate 104, the generated friction heat 602 is distributed in both members and will be transported away by heat conduction into the working surface 199 in case of a cooler working surface 199. When the cutter 108 passes an outlet opening 700, the cutter 108 comes into contact with the warmer nozzle which results in a heat transport from the nozzle and from the cut raw material into the cutter 108. This heat can be further transported to the cooler contact surface of the perforated plate 104 directly after the passing. Additionally, the cutter 108 is configured to be broader (“W”) than the nozzle or outlet opening 700 plus annular area 702 (“D”) in order to obtain proper interaction properties. This always results in a mixture of heating (when cutter 108 passes one of the outlet openings 700) and cooling (when cutter 108 is presently located between two of the outlet openings 700) of the cutter 108 by the perforated plate 104.

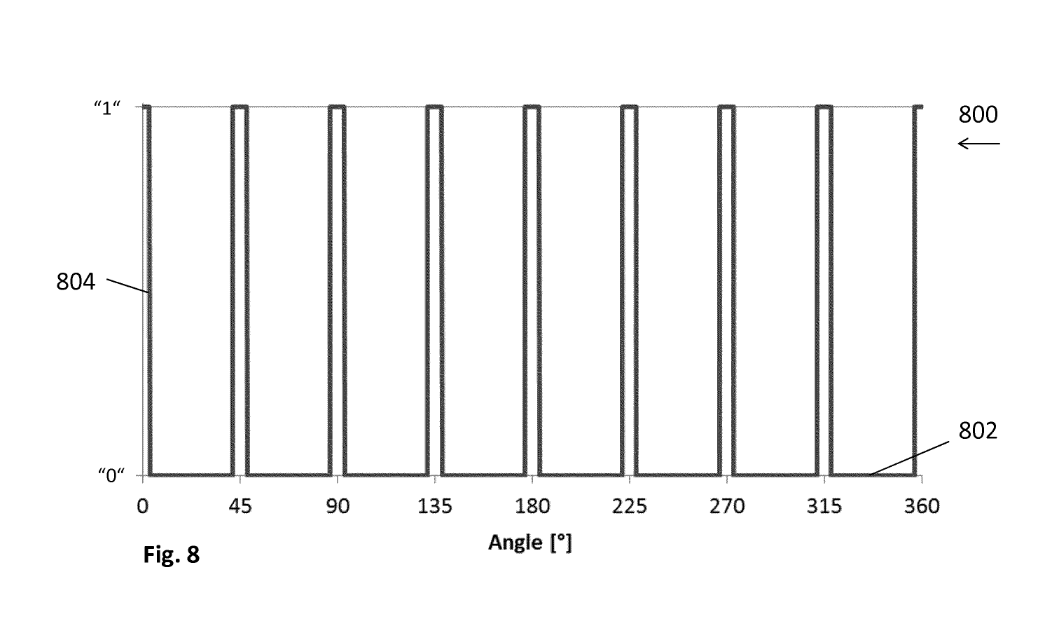

FIG. 8 schematically illustrates the heat flow between cutter 108 and perforated plate 104 during one rotation of the cutter 108 cooperating with the perforated plate 104 for the example of eight perforations 106 formed within the perforated plate 104.

More specifically, FIG. 8 illustrates a diagram 800 having an abscissa 802 along which a position along the pitch circle diameter of the working surface 199 of the perforated plate 104 relative to the cutter 108, defined in terms of a rotation angle, is plotted. Along an ordinate 804, a corresponding contact condition between cutter 108 and working surface 199 of the perforated plate 104 is plotted. A logical value “0” indicates a contact with a cold surface portion of the working surface 199, whereas a logical value “1” indicates a contact with a hot outlet opening 700. As can be taken from FIG. 8, most of the time the cutter 108 is in direct contact with the cold surface which results in an efficient net cooling of the cutter 108.

Therefore, FIG. 8 shows exemplarily and schematically the temperature profile along the perimeter of the working surface 199 of the perforated plate 104 for an embodiment with eight nozzle inserts or outlet openings 700 during one full rotation of the cutter 108. The cutter 108 is positioned at the perimeter of the perforated plate 104 and is about 15% of the time in contact with the hot nozzle material. In the present example, one hot area spot around the nozzle 702 covers approximately 1.8% of the area around the perimeter of the perforated plate 104. A proper ratio needs to be determined on a case-by-case basis. Thus, 28 nozzles with corresponding hot areas 702 would be possible for an exemplary configuration with a ratio of 50:50 between heating and cooling. The material combination between thermal isolation and perforated plate 104 should be selected in such a way that the perforated plate 104 has proper thermally conductive properties and abrasion resistance. For instance, a hard metal is a proper choice. The thermal isolation however should have a very low thermal conductivity. Thus, high temperature gradients at the positions of the inserted nozzles can be achieved, which also reduces or even minimizes hot regions on the working surface 199 of the perforated plate 104, which furthermore suppresses the influence of the sticky property of the raw material onto the pelletizing performance.

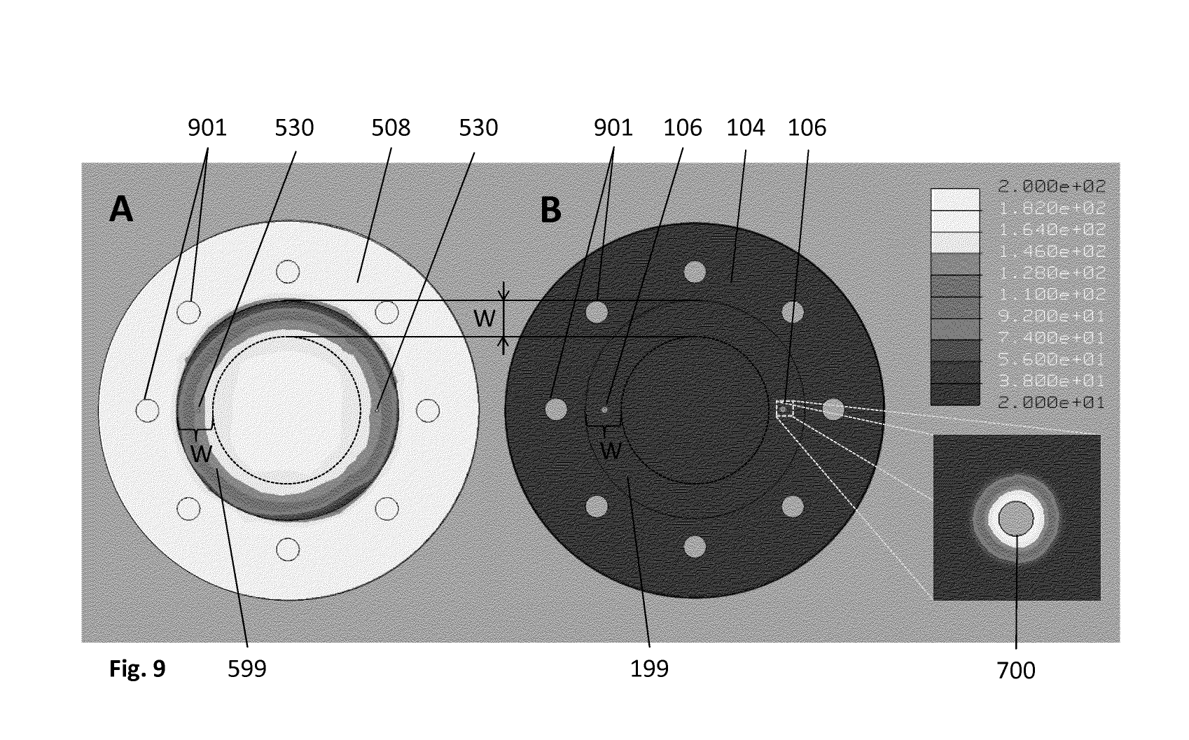

FIG. 9 shows a temperature profile of a perforated plate 508 with conventional heat coupling with a supply unit 502 (not shown) (left image, “A”) and a temperature profile of the perforated plate 104 being thermally decoupled from the supply unit 102 (not shown) according to an exemplary embodiment of the invention (right image, “B”). The perforated plates include through holes 901 for mounting. FIG. 9 shows therefore temperature profiles which are obtained from simulation results comparing the performance of the apparatus 100 according to FIG. 1 providing a perforated plate 104 with a separate heat management with the conventional apparatus 500 according to FIG. 5.

Boundary conditions for the conventional apparatus 500 are the following:
surface temperature of the flow channel adapter 506 is 200° C.
natural convection at the lateral area is 20 W/m²K
forced convection at the flange face is 150 W/m²K
surface temperature on the thermally insulating sealing 510 is 20° C. (water-cooled)
material of the perforated plate 508 is stainless steel (15 W/mK), and material of the sealing 510 is Teflon (0.25 W/mK)

Boundary conditions for the perforated plate 104 of the apparatus 100 according to an embodiment of the invention are the following:
surface temperature of the properly thermally conductive nozzle is 200° C.
natural convection at the lateral area is 20 W/m²K
forced convection at the flange face is 150 W/m²K
surface temperature on the properly thermally conductive sealing 130 is 20° C. (water-cooled)
material of the perforated plate 104 is sinter material (150 W/mK), and material of the sealing 130 is copper (300 W/mK)

A comparison between FIG. 9A and FIG. 9B clearly shows that the selective heat management according to an exemplary embodiment of the invention allows to obtain at the same time a cool working surface 199 of the perforated plate 104 as well as a hot outlet opening 700 of the perforated plate 104. In contrast to this, the conventional perforated plate 508 is significantly hotter as a result of the thermal coupling of the perforated plate 508 with the thermal management of the extruder 502. Conventionally, this high temperature level is necessary in order to ensure that the extrudate remains in a flowable state, however it results in an undesired adhesion of the extrudate at the working surface 599 and the knives.

FIG. 10A shows a three-dimensional view of a cutter 108 (which is implemented, as such, in conventional apparatuses as well) being implemented in the apparatus 100 for manufacturing particles according to an exemplary embodiment of the invention and being cooled to such a low temperature by thermal exchange with the perforated plate 104 that no adhesion of sticky viscous raw material takes place.

The cutter 108 comprises a mounting base 1000 which is mountable on a drive unit for being driven to rotate. A plurality of cutting elements 1002 are circumferentially arranged and connected to the mounting base 1000 and can cut a corresponding particle or granulate from a strand of raw material leaving a corresponding one of the perforations 106 of the perforated plate 104. Since the cutter 108 is cooled by thermal interaction with the perforated plate 104 according to an exemplary embodiment of the invention, it is and remains at a temperature below the solidification temperature of the raw material so that no raw material adheres to the cooled cutter 108. The knife width “W” and its motion define the size of the working surface 199. In the shown exemplary embodiment it results in an annular working surface 199.

FIG. 10B shows a three-dimensional view of a cutter being implemented in a conventional apparatus for manufacturing particles and being at such a high temperature that adhesion of sticky viscous raw material 1050 takes place. When the thermal management of the extruder on the one hand and the perforated plate and the cutter on the other hand are not separated, raw material 1050 may adhere at the cutter, compare FIG. 10B. Such problems can be overcome by exemplary embodiments of the invention.

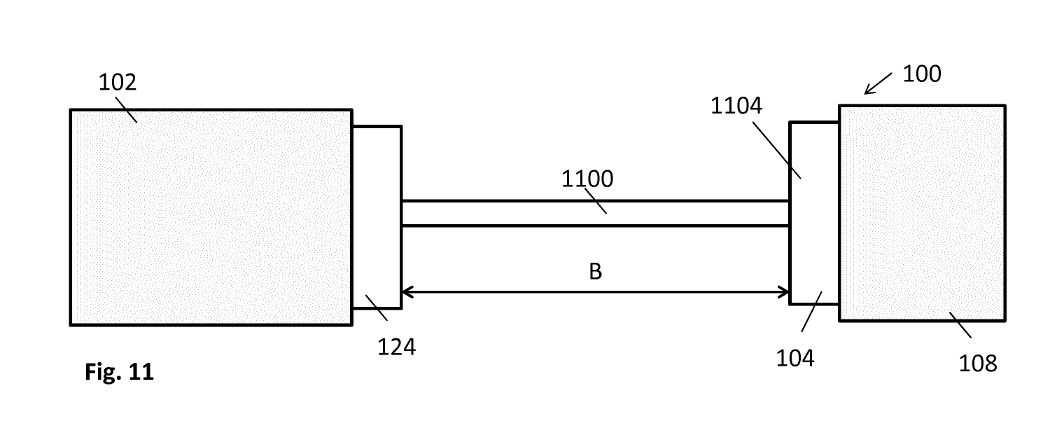

FIG. 11 is a schematic illustration of an apparatus 100 for manufacturing particles according to another exemplary embodiment of the invention.

Apparatus 100 has an oblong heated raw material conduit 1100 with such a large length B that the supply unit 102/flow channel adapter 124 arrangement on the one hand and the perforated plate 104/cutter 108 arrangement on the other hand are spatially separated over such a distance that they are consequently thermally decoupled from one another. Such an embodiment has the advantage that no thermally insulating structure 110 needs to be implemented which results in a lightweight apparatus. The forces acting on the perforated plate 104 are small. The perforated plate 100 for is therefore also accessible on a back surface 1104 which may simplify operation (e.g. selective heating and cooling), maintenance and repair. In an embodiment, the spacing B may be at least 1 mm, particularly at least 1 cm, more particularly at least 10 cm.

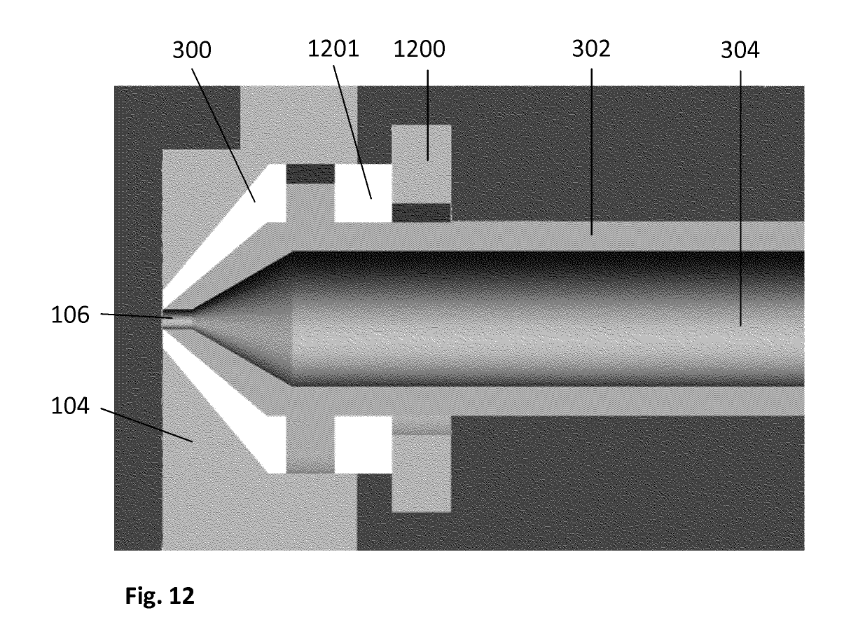

FIG. 12 shows a cross-sectional view of a thermally conductive tube 302 being surrounded by a thermally insulating sleeve 300 and both being inserted into a perforation 106 of a perforated plate 104 of an apparatus 100 for manufacturing particles according to an exemplary embodiment of the invention. A handling component 1200 simplifying handling of the nozzle insert constituted by the components with reference numerals 300, 302 is shown as well. The handling component is thermally decoupled from the nozzle via a thermal isolating ring 1201.

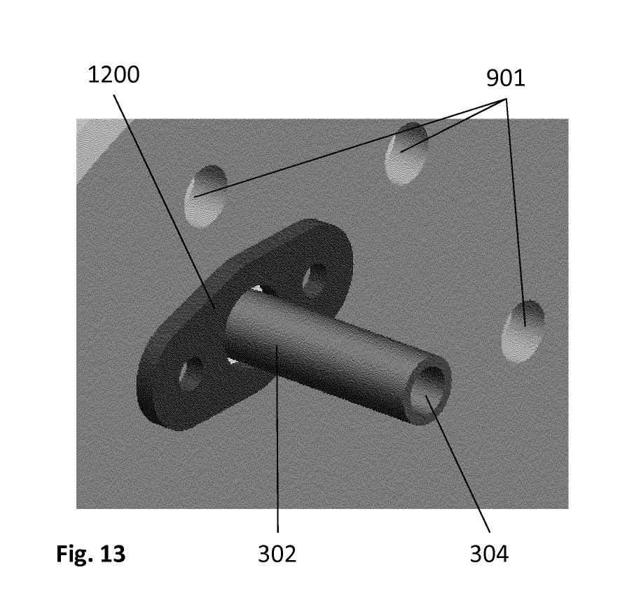

FIG. 13 shows a three-dimensional view of the arrangement of thermally conductive tube 302 and thermally insulating sleeve 300 of FIG. 12.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the invention is not limited to the preferred embodiments shown in the figures and described above. Instead, a multiplicity of variants are possible which use the solutions shown and the principle according to an embodiment of the invention even in the case of fundamentally different embodiments.

1-26. (canceled)

27. An apparatus for manufacturing particles, the apparatus comprising:
a supply unit adapted for supplying a viscous raw material;
a perforated body having a plurality of perforations and arranged to receive the viscous raw material from the supply unit to flow through the plurality of perforations;
a cutter arranged so that the viscous raw material flowing out of the plurality of perforations is cut into the particles by the cutter;
wherein the apparatus is configured so that, during manufacturing the particles, a temperature of at least a portion of the perforated body is lower than a temperature of the viscous raw material flowing through the plurality of perforations;
wherein the perforated body and the cutter are arranged relative to one another such that the cutter is cooled by thermal exchange with the perforated body during operation of the apparatus.

28. The apparatus of claim 27, wherein the perforated body is thermally decoupled from the supply unit, particularly by a thermally insulating structure separating the perforated body from the supply unit or by a sufficient spatial distance between the perforated body and the supply unit.

29. The apparatus of claim 28, comprising a heating unit integrated in the thermally insulating structure and configured for heating the raw material when flowing through a connection channel within the thermally insulating structure.

30. The apparatus of claim 27, wherein at least a part of the plurality of perforations is filled with a thermally insulating sleeve having a through hole, wherein in particular at least a part of the through holes of the thermally insulating sleeves is filled with a thermally conductive tube being thermally insulated from the perforated body by the thermally insulating sleeves and having a raw material supply channel for supplying the raw material received from the supply unit to the cutter.

31. The apparatus of claim 30, wherein at least a part of the thermally insulating sleeves and/or at least a part of the thermally conductive tubes has a tapering end facing the cutter.

32. The apparatus of claim 27, comprising a temperature adjustment unit configured for adjusting a temperature of at least a part of the supply unit without adjusting a temperature of the perforated body, wherein the temperature adjustment unit is in particular configured for adjusting the temperature of the supply unit so that the raw material is prevented from falling below a solidification temperature of the raw material, particularly from solidifying, while being processed by the supply unit.

33. The apparatus of claim 27, comprising a cooling unit configured for cooling selectively the perforated body, wherein the cooling unit is in particular configured for cooling the perforated body to such a temperature that the raw material is prevented from adhering to the perforated body and/or to the cutter upon cutting.

34. The apparatus of claim 33, wherein the perforated body and the cutter are arranged relative to one another such that the cutter is cooled by thermal exchange with the cooled perforated body.

35. The apparatus of claim 27, wherein the apparatus is configured so that, during manufacturing the particles, the temperature of at least a working surface, particularly a planar working surface, more particularly an annular planar working surface, of the perforated body facing the and cooperating with the cutter and surrounding the perforations is lower than the temperature of the viscous raw material flowing through the plurality of perforations, particularly is below a solidification temperature of the raw material, wherein in particular the working surface is made of a thermally conductive material.

36. The apparatus of claim 27, wherein the perforated body and the cutter are arranged relative to one another such that the cutter is in direct physical contact with a working surface, particularly with a planar working surface, more particularly with an annular planar working surface, of the perforated body during cutting.

37. The apparatus of claim 27, wherein the perforated body and the cutter are arranged relative to one another such that the cutter is spaced by a gap with regard to a working surface, particularly a planar working surface, more particularly an annular planar working surface, of the perforated body, which gap has such a small width, particularly a width of less than 1 mm, that temperature equilibration between the perforated body and the cutter occurs by thermal exchange during cutting.

38. The apparatus of claim 27, comprising at least one of the following:
a flow channel adapter arranged for continuously transforming a flow profile of the raw material from a profile adapted to the supply unit to a profile adapted to the perforated body, wherein particularly the profile adapted to the supply unit has a substantially 8-shaped cross-section and the profile adapted to the perforated body has a substantially circular cross-section, and
a heating unit configured for heating the flow channel adapter to prevent the raw material flowing through the flow channel adapter from falling below a solidification temperature of the raw material, particularly from solidifying.

39. The apparatus of claim 27, wherein at least a part of raw material outlets of the plurality of perforations of the perforated body has a diameter which is smaller than a width of a cutting edge of a cutting element of the cutter for cutting raw material exiting via a corresponding raw material outlet.

40. The apparatus of claim 27, comprising a thermally conductive sealing, wherein a flange face of the perforated body is sealingly mountable or mounted to a housing of the apparatus with the sealing in between, and wherein the apparatus comprises in particular a cooling unit configured for cooling the sealing.

41. The apparatus of claim 27, wherein the cutter is configured as one of the group consisting of an oscillating cutter and a rotating cutter.

42. The apparatus of 27, wherein the supply unit is configured as an extruder, particularly a twin-screw extruder having two cooperating screws.

43. The apparatus of claim 27, wherein at least 20%, particularly at least 50%, more particularly at least 70%, even more particularly at least 85%, of an area of a working surface, particular of an annular working surface, of the perforated body facing the cutter is lower than the temperature of the viscous raw material flowing through the plurality of perforations.

44. A method of manufacturing particles, the method comprising:
guiding viscous raw material through a plurality of perforations of a perforated body so that the viscous raw material flows through the plurality of perforations;
cutting the viscous raw material flowing out of the plurality of perforations into the particles by a cutter;
during manufacturing the particles, adjusting a temperature of at least a portion of the perforated body to be lower than a temperature of the viscous raw material flowing through the plurality of perforations;
arranging the perforated body and the cutter relative to one another such that the cutter is cooled by thermal exchange with the perforated body during manufacturing the particles.

45. The method of claim 44, wherein the temperature of at least the portion of the perforated body is adjusted to be lower than a solidification temperature of the viscous raw material.

46. The apparatus of claim 27 wherein the manufacturing particles are selected from a group consisting of food particles, plastic particles, dietary supplement particles, and pharmaceutical particles.

47. The method of claim 44 wherein the manufacturing particles are selected from a group consisting of food particles, plastic particles, dietary supplement particles, and pharmaceutical particles.
